(19) United States
(12) Patent Application Publication
(10) Pub. No.: US 2005/0035842 A1
(43) Pub. Date: Feb. 17, 2005

(54) Light emitting fuse having quick indication function

(76) Inventor: Chuan Shyu, Taichung (TW)

Correspondence Address: Charles E Baxley;Hart Baxley Daniels & Holton, Suite 309, 90 John Street, New York, NY, 10038, US

(21) Appl. No.: 10/643,473

(22) Filed: Aug. 15, 2003

(51) Int. Cl. H01H 85/32

(52) U.S. Cl. 337/265; 337/266

(57) ABSTRACT

A light emitting fuse includes two spaced conducting blades, and a light emitting diode electrically connected between the two spaced conducting blades. Thus, after the fuse wire connected between the two conducting blades is melted to form a disconnection state, the electric current from the power supply is forced to pass through the light emitting diode connected between the two conducting blades, so that the light emitting diode will light to produce an indication effect.

### BACKGROUND OF THE INVENTION

1. Field of the Invention

The present invention relates to a light emitting fuse, and more particularly to a light emitting fuse having a quick indication function.

2. Description of the Related Art

A conventional fuse 9 in accordance with the prior art shown in FIG. 5 comprises a housing 90, two spaced conducting blades 91 each mounted on the housing 90, and a fuse wire 92 mounted on the housing 90 and electrically connected between the two conducting blades 91. In practice, when the whole circuit forms a short circuit or the load is disposed at an abnormal state or breaks down, the fuse wire 92 is melted due to the greater heat of the current to form a disconnection state so as to protect the load from being worn out due to an excessive current.

However, the conventional fuse 9 does not have an indication function, so that the operator cannot correctly identify which one of the fuses 9 in the fuse box is worn out, thereby greatly causing inconvenience to the operator in maintenance and replacement of the fuses 9.

### SUMMARY OF THE INVENTION

The primary objective of the present invention is to provide a light emitting fuse having a quick indication function.

Another objective of the present invention is to provide a fuse box, wherein after the fuse wire connected between the two conducting blades is melted to form a disconnection state, the electric current from the power supply is forced to pass through the light emitting diode connected between the two conducting blades, so that the light emitting diode will light to produce an indication effect.

A further objective of the present invention is to provide a fuse box, wherein the operator can simultaneously inspect that the fuse is worn out easily and rapidly by indication of the light emitting diode, so as to replace the melted fuse easily and conveniently, thereby facilitating maintenance and replacement of the fuse.

A further objective of the present invention is to provide a fuse box, wherein the light emitting diode has a relatively high resistance, so that the electric current passing through the light emitting diode and the load is very small, thereby preventing the load from being worn out.

In accordance with the present invention, there is provided a light emitting fuse, comprising:
two spaced conducting blades; and
a light emitting diode electrically connected between the two spaced conducting blades.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a light emitting fuse in accordance with the preferred embodiment of the present invention;

FIG. 2 is a perspective view of the light emitting fuse in accordance with the preferred embodiment of the present invention;

FIG. 3 is a circuit diagram of the light emitting fuse in accordance with the preferred embodiment of the present invention;

FIG. 4 is a circuit diagram of the light emitting fuse in accordance with the preferred embodiment of the present invention; and

FIG. 5 is a perspective view of a conventional fuse in accordance with the prior art.

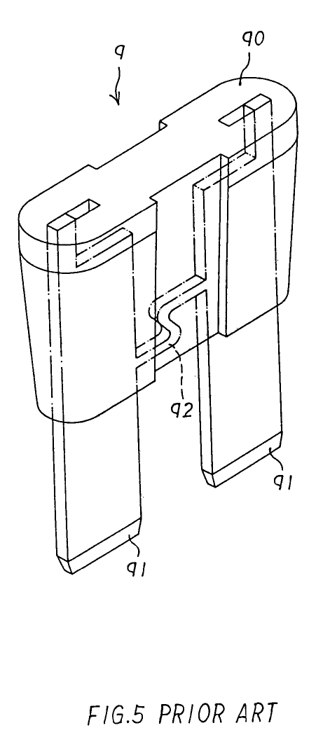

### DETAILED DESCRIPTION OF THE INVENTION

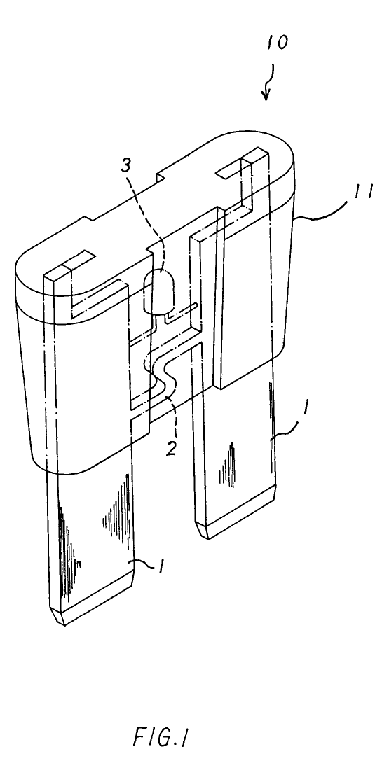

Referring to the drawings and initially to FIGS. 1-3, a light emitting fuse 10 in accordance with the preferred embodiment of the present invention comprises a housing 11, two spaced conducting blades 1 each mounted on the housing 11, a fuse wire 2 mounted on the housing 11 and electrically connected between the two conducting blades 1, and a light emitting diode 3 mounted on the housing 11 and electrically connected between the two conducting blades 1. The light emitting diode 3 has a relatively high resistance and is electrically connected with the fuse wire 2 in a parallel manner. Thus, after the fuse wire 2 between the two conducting blades 1 is melted, the electric current is forced to pass through the light emitting diode 3, so that the light emitting diode 3 will light to produce an indication effect.

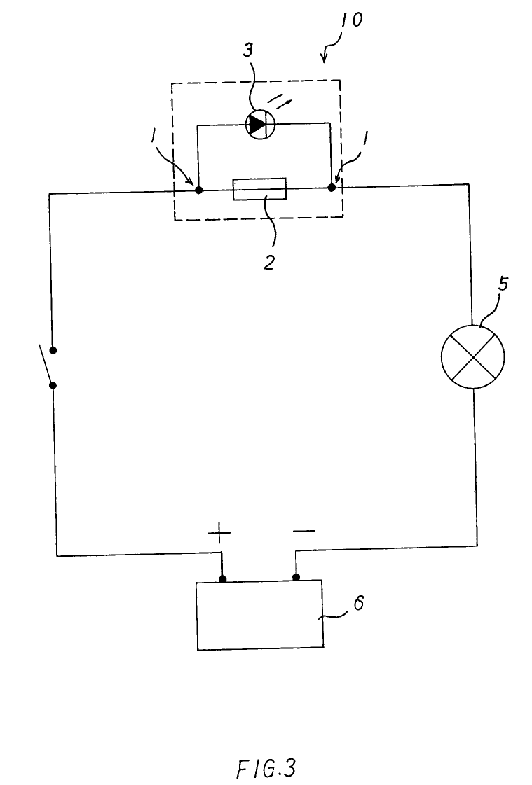

In practice, as shown in FIG. 3, the light emitting diode 3 is electrically connected with the fuse wire 2 in a parallel manner and has a resistance much greater than that the fuse wire 2. Thus, at the normal state, the electric current from the power supply 6 directly passes through the fuses 3 without passing through the light emitting diode 3.

Alternatively, when the whole circuit forms a short circuit or the load 5 is disposed at an abnormal state or breaks down, the fuse wire 2 is melted due to the greater heat of the current so as to form a disconnection state. After the fuse wire 2 connected between the two conducting blades 1 is melted to form a disconnection state, the electric current from the power supply 6 is forced to pass through the light emitting diode 3 connected between the two conducting blades 1, so that the light emitting diode 3 will light to produce an indication effect. In such a manner, the operator can simultaneously inspect that the fuse 10 is worn out easily and rapidly by indication of the light emitting diode 3, so as to replace the melted fuse 10 easily and conveniently, thereby facilitating maintenance and replacement of the fuse 10.

In addition, the light emitting diode 3 has a relatively high resistance, so that the electric current passing through the light emitting diode 3 and the load 5 (see FIG. 3) is very small, thereby preventing the load 5 from being worn out.

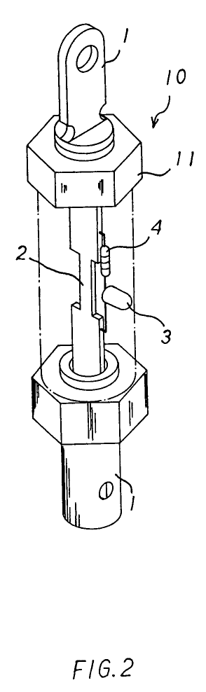

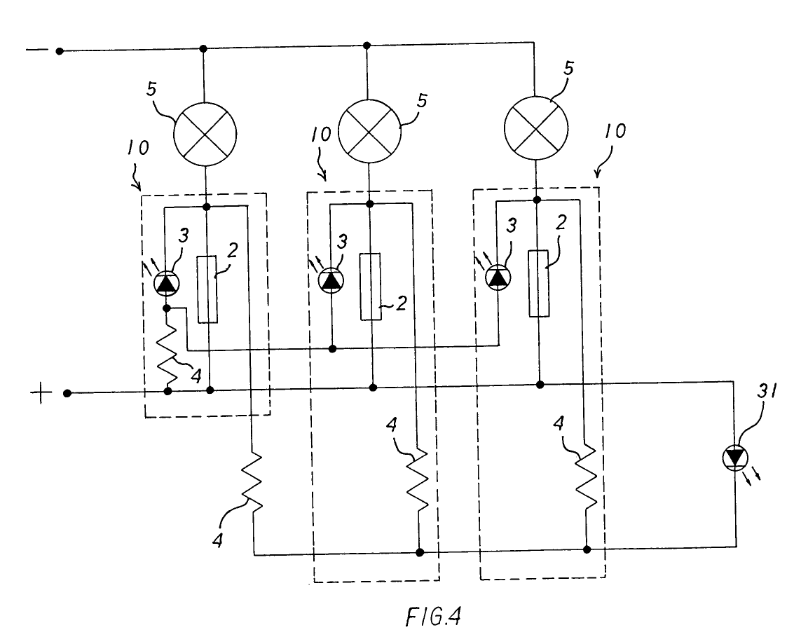

In addition, as shown in FIGS. 2 and 4, the light emitting diode 3 is connected with a resistor 4 having a relatively high resistance, so that the light emitting diode 3 has a relatively high resistance.

As shown in FIG. 4, the fuse box comprises three fuses 10, and further comprises an indication lamp 31 electrically connected with the fuse wire 2 of each of the fuses 10 in a serial manner, so that the indication lamp 31 can light when either one of the fuses 10 is melted or worn out so as to notify the operator one of the fuses 10 is worn out.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A light emitting fuse, comprising:
two spaced conducting blades; and
a light emitting diode electrically connected between the two spaced conducting blades.

2. The light emitting fuse in accordance with claim 1, further comprising a fuse wire electrically connected between the two conducting blades.

3. The light emitting fuse in accordance with claim 2, wherein the light emitting diode is electrically connected with the fuse wire in a parallel manner.

4. The light emitting fuse in accordance with claim 3, wherein after the fuse wire between the two conducting blades is melted, the electric current is forced to pass through the light emitting diode, so that the light emitting diode will light to produce an indication effect.

5. The light emitting fuse in accordance with claim 2, wherein the light emitting diode has a resistance much greater than that the fuse wire.

6. The light emitting fuse in accordance with claim 1, wherein the light emitting diode has a relatively high resistance.

7. The light emitting fuse in accordance with claim 1, wherein the light emitting diode is connected with a resistor having a relatively high resistance, so that the light emitting diode has a relatively high resistance.

8. The light emitting fuse in accordance with claim 1, further comprising an indication lamp electrically connected with the fuse wire of the fuse in a serial manner.
